(19) United States
(12) Patent Application Publication
(10) Pub. No.: US 2020/0249883 A1
(43) Pub. Date: Aug. 6, 2020

(54) IMAGE FORMING APPARATUS, IMAGE FORMING SYSTEM, AND INFORMATION PROCESSING METHOD

(71) Applicant: Konica Minolta, Inc., Tokyo (JP)

(72) Inventor: Masaki Nakata, Toyohashi-shi (JP)

(73) Assignee: Konica Minolta, Inc., Tokyo (JP)

(21) Appl. No.: 16/740,623

(22) Filed: Jan. 13, 2020

(30) Foreign Application Priority Data
Feb. 4, 2019 (JP) 2019-017625

(51) Int. Cl. G06F 3/12; G06F 3/16; G10L 17/00

(52) U.S. Cl. CPC G06F 3/1208; G06F 3/167; G06F 3/1255; G10L 17/005; G06F 3/1239; G06F 3/1222; G06F 3/1256

(57) ABSTRACT

An image forming apparatus includes: a hardware processor that: receives, by voice of a first user, a setting instruction related to a setting of a job executed by the image forming apparatus; receives, by voice of a second user, an operation instruction for executing the job; specifies the first user and the second user based on the voices; associates and stores, in a storage, a setting according to the setting instruction and identification information of the first user; and extracts from the storage, upon receiving the operation instruction after receiving the setting instruction, the setting associated with identification information of the second user, and executes the job based on the extracted setting.

### CROSS-REFERENCE TO RELATED APPLICATION

The entire disclosure of Japanese patent Application No. 2019-017625, filed on Feb. 4, 2019, is incorporated herein by reference.

### BACKGROUND

### Technical Field

The present invention relates to an image forming apparatus, an image forming system, and an information processing method.

### Description of the Related Art

Conventionally, an image forming apparatus that is a copying machine, a printer, a facsimile, or a multi-functional peripheral thereof is known. Further, as disclosed in JP 2006-205497 A, there is known a multi-functional peripheral that can instruct an input operation of an operation part by a voice input.

An input operation by voice is intuitive for a user. Further, since the user does not need to search for a target item from a menu having a hierarchical structure on an operation panel, quick input is possible. As described above, the input operation by voice is highly convenient.

In addition, JP 2005-78072 A discloses an audio visual (AV) device that performs voice recognition and speaker recognition on an inputted voice signal when user's voice is inputted from a wireless microphone of a remote control, and makes a determination on an inputted instruction word to provide a personalized service for the corresponding user.

Meanwhile, in an operation instruction by voice for an image forming apparatus, the image forming apparatus may erroneously recognize voice generated by other than the user. For example, in an environment with an unspecified number of people such as an office environment, the image forming apparatus may erroneously recognize voice generated by a person other than the user as an instruction to the image forming apparatus, during an operation of the image forming apparatus.

Specific examples are as follows. When a person other than the user of the image forming apparatus speaks “please send a document by fax” on a phone while an instruction is given to the image forming apparatus by voice, the image forming apparatus receives the instruction as an instruction for the image forming apparatus. Further, when a person other than the user of the image forming apparatus speaks “please make a photocopy of this document” for asking another person to make a photocopy of the document while an instruction is given to the image forming apparatus by voice, the image forming apparatus receives the instruction as an instruction for the image forming apparatus.

In this regard, in the technique disclosed in JP 2005-78072 A, it is possible to specify a user who has given an operation instruction to the AV device, by performing speaker recognition by speech.

However, in general, in an operation for the image forming apparatus, a plurality of settings is performed as separate voice instructions, and an operation instruction for causing the image forming apparatus to execute a job is performed at the end.

Therefore, if another user gives a setting instruction before the user gives an operation instruction, the job is executed in a state where settings unintended by the user who has given the operation instruction are made, even when speaker recognition is performed for each of the setting instructions and the operation instruction.

### SUMMARY

One or more embodiments of the present invention improve operability of a voice operation on an image forming apparatus, in an environment where a plurality of people speaks at a same time.

An image forming apparatus of one or more embodiments of the present invention comprises a hardware processor that: receives, by voice, a setting instruction related to a setting of a job to be executed by the image forming apparatus and an operation instruction for causing the job to be executed; specifies a user who has given the setting instruction (first user) and a user who has given the operation instruction (second user) on the basis of the voice; associates and stores, in a storage, a setting according to the setting instruction and identification information of the specified user, on the basis of a fact that a user who has given the setting instruction is specified; and extracts, from the storage, the setting associated with identification information of a same user as a user who has given the operation instruction on the basis of a fact of receiving the operation instruction after receiving the setting instruction, and causes the job to be executed on the basis of the extracted setting.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing a schematic configuration of an image forming system according to one or more embodiments;

FIG. 2 is a view for explaining processing executed by an image forming apparatus according to one or more embodiments;

FIG. 3 is an outline view showing an internal structure of the image forming apparatus according to one or more embodiments;

FIG. 4 is a block diagram showing an example of a hardware configuration of a main body of the image forming apparatus according to one or more embodiments;

FIG. 5 is a functional block diagram for explaining a functional configuration of the image forming apparatus according to one or more embodiments;

FIG. 6 is a schematic view showing an example of a data table stored in the image forming apparatus according to one or more embodiments;

FIG. 7 is a view for explaining a screen displayed on a display of an operation panel according to one or more embodiments;

FIG. 8 is a view for explaining another screen displayed on the display of the operation panel according to one or more embodiments;

FIG. 9 is a view for explaining still another screen displayed on the display of the operation panel according to one or more embodiments;

FIG. 10 is a flowchart showing a processing flow until reception of a voice input is started according to one or more embodiments;

FIG. 11 is a flowchart for explaining a first half of a processing flow of the image forming apparatus when a voice input is received according to one or more embodiments;

FIG. 12 is a flowchart for explaining a second half of the processing flow of the image forming apparatus when a voice input is received according to one or more embodiments; and

FIG. 13 is a view for explaining a screen displayed on the display of the operation panel when an inquiry to a job execution user is made according to one or more embodiments.

### DETAILED DESCRIPTION

Hereinafter, embodiments of an image forming apparatus will be described with reference to the drawings. However, the scope of the invention is not limited to the disclosed embodiments. In the embodiments described below, in referring to a number, an amount, and the like, the scope of the present invention is not necessarily limited to the number, the amount, and the like unless otherwise specified. The same parts and corresponding parts are denoted by the same reference numerals, and redundant description may not be repeated.

In the drawings, there are points that are not illustrated in accordance with a ratio of actual dimensions, but are illustrated with a ratio changed so as to clarify a structure in order to facilitate understanding of the structure. Note that one or more embodiments described below may be selectively combined as appropriate.

Further, in the following, an image forming apparatus as a color printer will be described, but the image forming apparatus is not limited to a color printer. For example, the image forming apparatus may be a monochrome printer, may be a FAX, or may be a multi-functional peripheral (MFP) of a monochrome printer, a color printer, and a FAX.

<A. System Configuration>

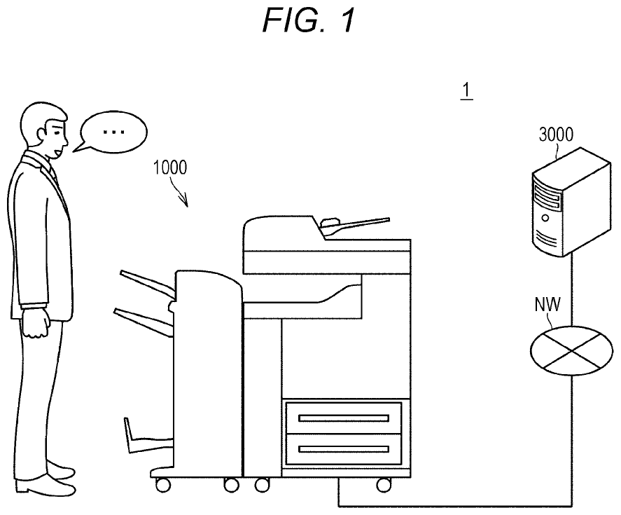

FIG. 1 is a view showing a schematic configuration of an image forming system 1 according to one or more embodiments.

Referring to FIG. 1, the image forming system 1 includes an image forming apparatus 1000 that is an MFP, and a server device 3000. The image forming apparatus 1000 is communicably connected to the server device 3000 via a network NW. Functions of the server device 3000 will be described later.

The image forming apparatus 1000 executes various jobs. Settings of the job include: settings related to operating conditions, such as a single-sided/double-sided mode, a color/monochrome mode, an N-in-1 (aggregate copy) mode, a staple (finisher) mode, a paper setting, and a number of copies; and settings related to job execution, such as a setting of a transmission destination, a setting of a box to be designated, and a selection setting of a document in a box.

As settings of the job, there are: settings in which job settings are changed as necessary from settings registered in advance (typically, default settings); and settings that have not been set by default, such as a setting of a transmission destination and designation of a document. The settings in one or more embodiments of the present invention include both of these.

For example, in a case of a fax transmission job, the destination setting has not been set by default, but is set on the basis of a user instruction.

Further, in a case of a job for printing a document in a box, first, a setting for designation of the box, then a setting for selecting a document in the box, and then a setting of print conditions is subsequently performed, and the job is executed with speech of printing start. At this time, the former two settings are set in accordance with a user instruction. Conditions instructed by the user to change from the default settings are exclusively changed in the setting of print conditions, and the job is executed. The speech of printing start corresponds to the operation instruction.

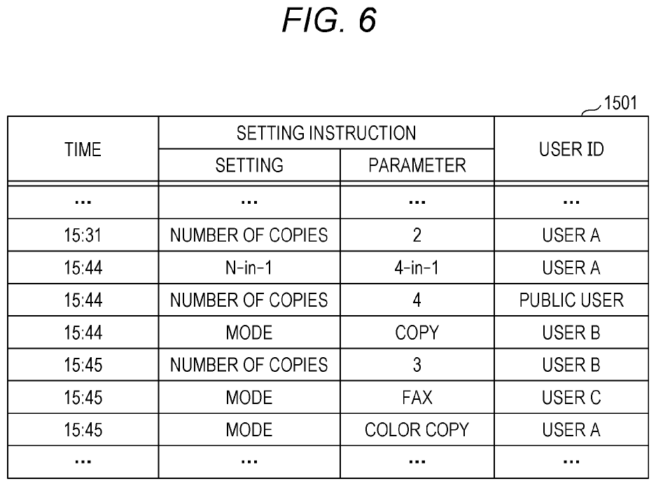

Note that an instruction for setting a job (hereinafter also referred to as “setting instruction”) may include a parameter such as a number of copies (see FIG. 6).

<B. Outline of Processing>

An outline of processing performed by the image forming apparatus 1000 will be described with a specific example.

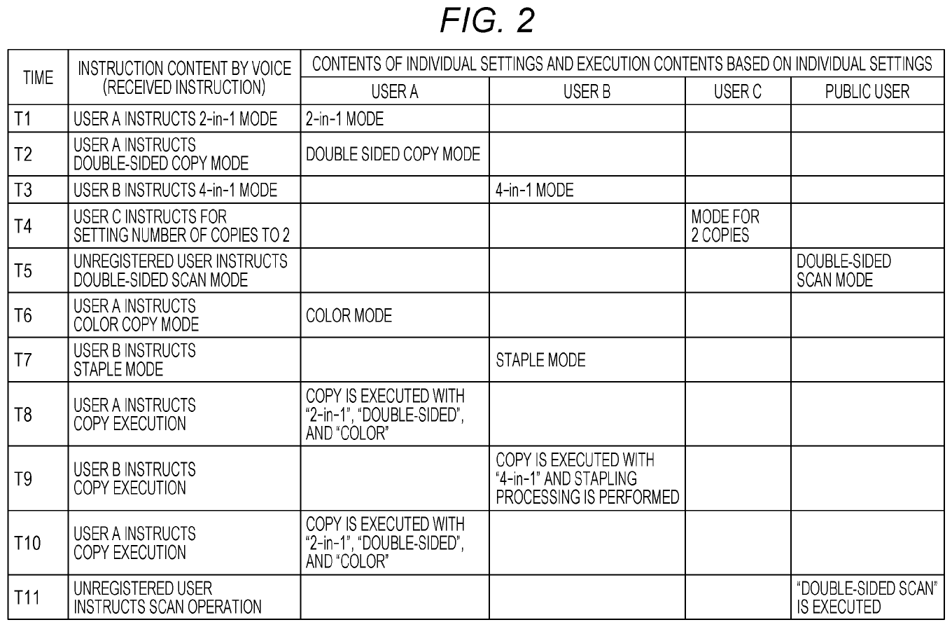

FIG. 2 is a view for explaining processing executed by the image forming apparatus 1000.

(b1. Times T1 to T7)

Referring to FIG. 2, a setting instruction for setting a job is given by voice at times T1 to T7.

At time T1, a user A (first user) of the image forming apparatus 1000 instructs “2-in-1 mode” by voice. In this case, the image forming apparatus 1000 specifies that a speaker of the voice is the user A from among a plurality of registered users by voice recognition, and stores that an instruction content (a change content from the default in this case) is “2-in-1” setting, in a memory in the image forming apparatus 1000.

Typically, the image forming apparatus 1000 uses a database that stores voice characteristics of each of the plurality of users in association with identification information of each user, to specify the user who has given the setting instruction. Note that information about each user necessary for voice recognition is stored in advance in the image forming apparatus 1000 or the server device 3000. In a case where the information is stored in the server device 3000, the image forming apparatus 1000 requests the server device 3000 for voice recognition processing.

At time T2, the user A instructs “double-sided copy mode” by voice. In this case, the image forming apparatus 1000 specifies that a speaker of the voice is the user A by voice recognition, and stores in the memory that the instruction content is the “double-sided copy” setting.

At time T3, a user B instructs “4-in-1 mode” by voice. In this case, the image forming apparatus 1000 specifies that a speaker of the voice is the user B by voice recognition, and stores in the memory that the instruction content is the “4-in-1” setting.

At time T4, a user C instructs for setting two copies as the number of copies, by voice. In this case, the image forming apparatus 1000 specifies that a speaker of the voice is the user C by voice recognition, and stores in the memory that the instruction content is the “two copies” setting.

At time T5, a user who is not registered in advance instructs “double-sided scan mode” by voice. In this case, the image forming apparatus 1000 is not able to specify a speaker of the voice, and therefore stores in the memory that the speaker is a public (unregistered) user and the instruction content is the “double-sided scan” setting.

At time T6, the user A instructs “color mode” by voice. In this case, the image forming apparatus 1000 specifies that a speaker of the voice is the user A by voice recognition, and stores in the memory that the instruction content is the “color mode” setting.

At time T7, the user B instructs “staple mode” by voice. In this case, the image forming apparatus 1000 specifies that a speaker of the voice is the user B by voice recognition, and stores in the memory that the instruction content is the “staple” setting.

In this way, the image forming apparatus 1000 stores the setting instructions by voice made at times T1 to T7 in the memory, in association with the user who has given each setting instruction.

(b2. Times T8 to T11)

At times T8 to T11, an operation instruction for causing execution of a job is given by voice.

At time T8, the user A gives a copy execution instruction by voice. In this case, the image forming apparatus 1000 extracts a setting associated with the user A from the memory, and executes the job on the basis of the extracted setting. Specifically, the image forming apparatus 1000 extracts the “2-in-1” setting, the “double-sided copy” setting, and the “color mode” setting associated with the user A, from the memory. Further, the image forming apparatus 1000 executes copying with “2-in-1”, “double-sided”, and “color”. At this time, default settings are applied to a setting other than the extracted setting, that is, a setting other than “2-in-1”, “double-sided”, and “color”. For example, an upper stage of a paper feeding cassette, one copy as the number of copies, and the like are applied as the default settings.

At time T9, the user B (second user) gives a copy execution instruction by voice. In this case, the image forming apparatus 1000 extracts a setting associated with the user B from the memory, and executes the job on the basis of the extracted setting. Specifically, the image forming apparatus 1000 extracts the “4-in-1” setting and the “staple” setting associated with the user B from the memory. Further, the image forming apparatus 1000 executes copying with “4-in-1”, and then executes stapling processing (post-processing) on the outputted paper.

At time T10, the user A again gives a copy execution instruction by voice. In this case, the image forming apparatus 1000 executes copying with the same setting as the setting made at time T8. That is, the image forming apparatus executes copying with “2-in-1”, “double-sided”, and “color”.

At time T11, the unregistered user gives a scan execution instruction by voice. In this case, the image forming apparatus 1000 extracts a setting associated with the public user from the memory, and executes the job on the basis of the extracted setting. Specifically, the image forming apparatus 1000 extracts the “double-sided scan” setting associated with the public user from the memory. Further, the image forming apparatus 1000 scans both sides of paper.

(b3. Summary)

(1) The image forming apparatus 1000 receives, by voice, a setting instruction related to a setting of a job to be executed by the image forming apparatus 1000 (see times T1 to T7). Further, the image forming apparatus 1000 receives, by voice, an operation instruction for causing the job to be executed (see times T8 to T11).

The image forming apparatus 1000 specifies the user who has given the setting instruction on the basis of the voice. In addition, the image forming apparatus 1000 specifies the user who has given the operation instruction on the basis of the voice.

On the basis of the fact that the user who has given the setting instruction is specified, the image forming apparatus 1000 associates and stores, in the memory, a setting according to the setting instruction (that is, a content of the setting instruction) and identification information of the specified user. For example, regarding the instruction at time T1, the image forming apparatus 1000 stores the setting “2-in-1” in association with the user A.

On the basis of the fact of receiving the operation instruction after receiving the setting instruction, the image forming apparatus 1000 extracts a setting associated with the identification information of the same user as the user who has given the operation instruction from the memory, and executes the job on the basis of the extracted setting. For example, when the user A gives a copy execution instruction (operation instruction) at time T8, a setting associated with the user A (specifically, “2-in-1”, “double-sided”, “color”) is extracted from the memory, and copying is executed with “2-in-1”, “both sides”, and “color”.

According to this configuration, even if another user (for example, the user B) gives a setting instruction before one user (for example, the user A) gives an operation instruction, the job is not to be executed in a state where settings unintended by the user who has given the operation instruction are made.

Therefore, according to the image forming apparatus 1000, it is possible to improve operability of a voice operation on the image forming apparatus 1000, in an environment where a plurality of people speaks at a same time.

(2) In a case where a new (another) operation instruction is received from the user B other than the user A who has given the operation instruction (time T9) after the above-mentioned job is executed on the basis of the operation instruction from the user A, the image forming apparatus 1000 extract, from the memory, a setting (specifically, “4-in-1”, “staple”) associated with identification information of the same user (that is, the user B) as the user who has given the new operation instruction, and sets the extracted setting as a setting for the user B. The image forming apparatus 1000 executes a job (specifically, copying) based on the new operation instruction with the setting, on the basis of the fact that the setting is set as the setting for the user B.

According to this configuration, for example, even if another user (for example, the user A) gives an operation instruction before the user B gives the operation instruction, the image forming apparatus 1000 can execute the job with settings intended by the user B.

(3) The image forming apparatus 1000 uses a database that stores voice characteristics of each of a plurality of users in association with identification information of each user, to specify the user who has given the setting instruction. In addition, the image forming apparatus 1000 uses the database to specify the user who has given the operation instruction.

(4) In a case where the user who has given the setting instruction is not able to be identified from the database, the image forming apparatus 1000 performs processing on the assumption that the setting instruction has been given by a public user (that is, the public user is specified as the user who has given the setting instruction) (see time T5). Further, in a case where the user who has given the operation instruction is not able to be identified from the database, the image forming apparatus 1000 performs processing on the assumption that the operation instruction has been given by the public user (that is, the public user is specified as the user who has given the operation instruction) (see time T11).

According to this configuration, even for a user who has not been subjected to user registration, the image forming apparatus 1000 can execute a job with settings intended by the user.

(5) Specifically, in a case where a user who has given the setting instruction cannot be identified, the image forming apparatus 1000 associates identification information of a public user with the setting instruction stored in the memory. In a case where the user who has given the operation instruction cannot be identified (see time T11), the image forming apparatus 1000 extracts a setting instruction (specifically, “double-sided scan”) associated with identification information of the public user from the memory, and executes the job on the basis of the extracted setting.

(6) Every time when receiving a setting instruction, the image forming apparatus 1000 specifies a user who has given the setting instruction.

According to this configuration, in a case where the setting instruction may be for the user (for example, when the setting instruction is prohibited in relation to the previous setting instruction), the image forming apparatus 1000 can immediately notify the user that the setting instruction is inappropriate, through display or the like.

<C. Hardware Configuration of Image Forming Apparatus 1000>

(c1. Internal Structure of Image Forming Apparatus 1000)

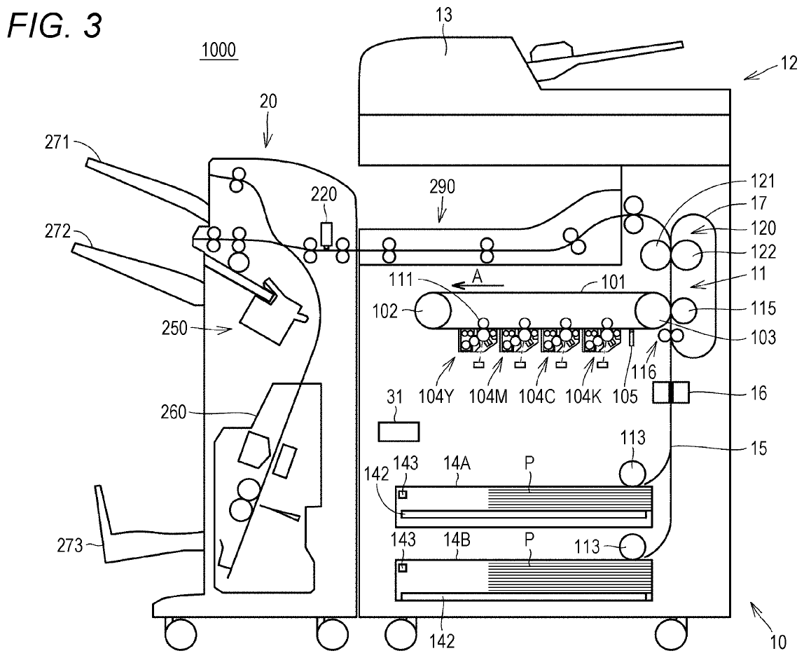

FIG. 3 is an outline view showing an internal structure of the image forming apparatus 1000. Referring to FIG. 3, as described above, the image forming apparatus 1000 includes a main body 10 and a post-processing device 20.

The main body 10 includes an image forming unit 11, a scanner unit 12, an automatic document conveyance unit 13, paper feeding trays 14A and 14B, a conveyance path 15, a media sensor 16, a reverse conveyance path 17, and a paper feeding roller 113.

The main body 10 further includes a controller 31 that controls an operation of the image forming apparatus 1000. Note that, in this example, the main body 10 is a so-called tandem color printer. The main body 10 executes image formation on the basis of print settings.

The automatic document conveyance unit 13 automatically conveys a document placed on a document table, to a reading position of a document reading part. The scanner unit 12 reads an image of the document conveyed by the automatic document conveyance unit 13, and generates read data.

Paper P is stored in the paper feeding trays 14A and 14B. The paper feeding roller 113 feeds the paper P upward along the conveyance path 15. Each of the paper feeding trays 14A and 14B includes a bottom raising plate 142 and a sensor 143. The sensor 143 detects a position of a regulation plate (not shown) in the paper feeding tray, and detects a size of paper.

The conveyance path 15 is used for single-sided printing and double-sided printing. The reverse conveyance path 17 is used for double-sided printing.

The image forming unit 11 forms an image on the paper P supplied from the paper feeding trays 14A and 14B, on the basis of the read data generated by the scanner unit 12, or print data acquired from a PC (not shown).

The image forming unit 11 includes an intermediate transfer belt 101, a tension roller 102, a driving roller 103, a yellow image forming part 104Y, a magenta image forming part 104M, a cyan image forming part 104C, a black image forming part 104K, an image density sensor 105, a primary transfer device 111, a secondary transfer device 115, a registration roller pair 116, and a fixing device 120 including a heating roller 121 and a pressure roller 122. The tension roller 102 and the driving roller 103 hold the intermediate transfer belt 101, and rotate the intermediate transfer belt 101 in a direction A in the figure. The registration roller pair 116 conveys, further downstream, the paper P conveyed by the paper feeding roller 113.

The media sensor 16 is installed in the conveyance path 15. The media sensor 16 realizes an automatic paper-type detection function.

Note that the post-processing device 20 further includes a punch processing device 220, a side stitching processing part 250, a saddle stitching processing part 260, a discharge tray 271, a discharge tray 272, and a lower discharge tray 273.

(c2. Hardware Configuration of Main Body 10)

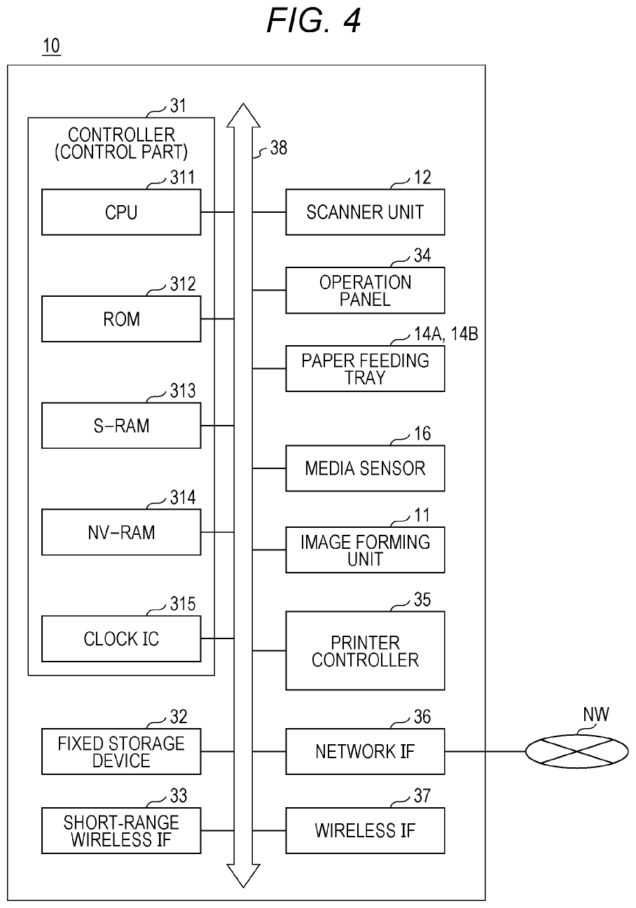

FIG. 4 is a block diagram showing an example of a hardware configuration of the main body 10 of the image forming apparatus 1000.

Referring to FIG. 4, the main body 10 includes the controller 31, a fixed storage device 32, a short-range wireless interface (IF) 33, the scanner unit 12, an operation panel 34, and the paper feeding trays 14A and 14B, the media sensor 16, the image forming unit 11, a printer controller 35, a network IF 36, and a wireless IF 37. Each of the parts 11, 12, 14A, 14B, 16, and 32 to 37 is connected to the controller 31 via a bus 38.

The controller 31 includes a central processing unit (CPU) 311, a read only memory (ROM) 312 that stores a control program, a static random access memory (S-RAM) 313 for work, a battery-backed non-volatile RAM (NV-RAM, non-volatile memory) 314 that stores various settings related to image formation, and a clock integrated circuit (IC) 315. The parts 311 to 315 each are connected via the bus 38.

The operation panel 34 includes keys for performing various inputs and a display unit. The operation panel 34 typically includes a touch screen and hardware keys. Meanwhile, the touch screen is a device in which a touch panel is superimposed on a display.

The network IF 36 transmits and receives various types of information to and from external devices such as a PC (not shown) and other image forming apparatuses (not shown) connected via the network NW.

The printer controller 35 generates a copy image from print data received by the network IF 36. The image forming unit 11 forms the copy image on paper.

Note that the fixed storage device 32 is typically a hard disk device. The fixed storage device 32 stores various data.

<D. Functional Configuration of Image Forming Apparatus 1000>

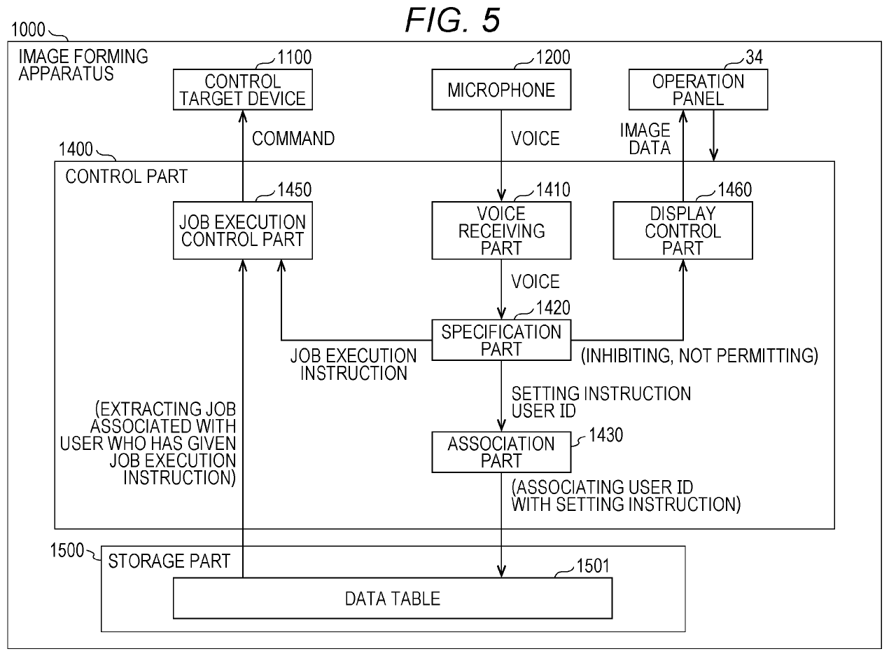

FIG. 5 is a functional block diagram for explaining a functional configuration of the image forming apparatus 1000.

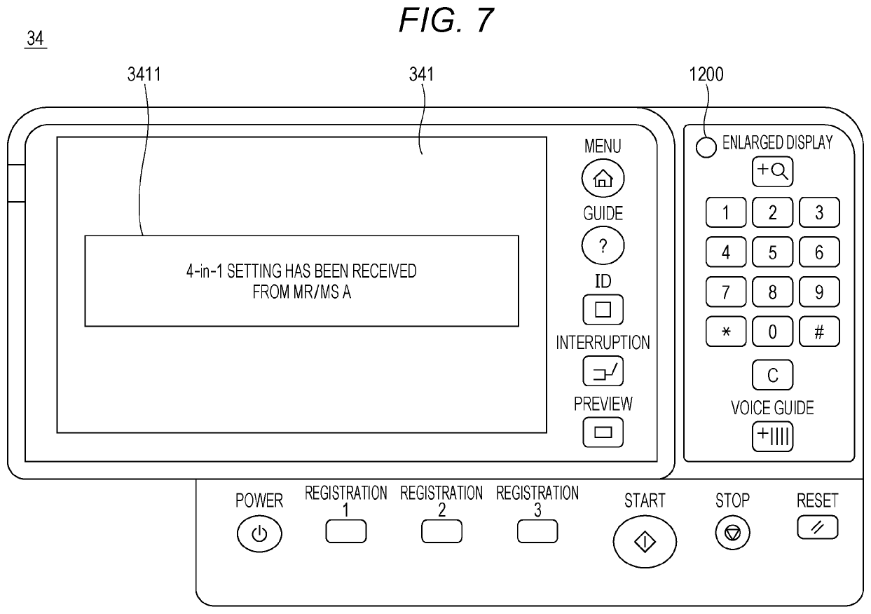

Referring to FIG. 5, the image forming apparatus 1000 includes a control target device 1100, a microphone 1200, the operation panel 34, a control part 1400, and a storage part 1500. Note that the microphone 1200 may be incorporated in the operation panel 34, for example (see FIGS. 7 to 9).

The control target device 1100 is a device that operates on the basis of a command from the control part 1400. Examples of the control target device 1100 include devices such as the image forming unit 11, the scanner unit 12, the automatic document conveyance unit 13, the paper feeding roller 113, and the post-processing device 20.

The microphone 1200 collects sound generated around the image forming apparatus 1000 (specifically, around the microphone 1200). In one or more embodiments, the microphone 1200 collects voice spoken by a user. The microphone 1200 sends the collected sound to the control part 1400.

The operation panel 34 typically includes a touch screen and physical keys. The touch screen includes a display and a touch panel. The operation panel 34 displays various screens on the basis of a command from the control part 1400. For example, the operation panel 34 displays software keys on the display. When the operation panel 34 receives an input from the user while the operation screen is displayed, the operation panel 34 sends a signal corresponding to the received key to the control part 1400.

The control part 1400 corresponds to the controller 31 (see FIG. 3). Typically, the control part 1400 is realized by a hardware processor (CPU 311) executing an operating system (OS) and various programs stored in a memory.

The control part 1400 includes a voice receiving part 1410, a specification part 1420, an association part 1430, a job execution control part 1450, and a display control part 1460.

The storage part 1500 stores a data table 1501 (or a database). The data table 1501 is accessed from the control part 1400. Specifically, the control part 1400 writes data to the data table 1501 and reads data from the data table 1501.

Hereinafter, details of processing of the control part 1400 will be described.

(d1. Voice Receiving Part 1410)

The voice receiving part 1410 receives voice collected by the microphone 1200. Specifically, the voice receiving part 1410 receives a setting instruction for setting a job to be executed by the image forming apparatus 1000, and an operation instruction for causing execution of a job (hereinafter also referred to as a “job execution instruction”) by voice.

The voice receiving part 1410 typically performs predetermined signal processing such as sampling processing and noise removal, and sends voice data to the specification part 1420.

(d2. Specification Part 1420)

The specification part 1420 specifies a speaker of voice and an instruction content by voice analysis.

The specification part 1420 determines whether or not the instruction content is for the image forming apparatus 1000. Further, when the instruction content is for the image forming apparatus 1000, the specification part 1420 determines whether or not the instruction content is a setting instruction. Furthermore, when the instruction content is for the image forming apparatus 1000, the specification part 1420 determines whether or not the instruction content is a job execution instruction.

Typically, the specification part 1420 specifies a speaker of voice from a plurality of users registered in advance. Specifically, the specification part 1420 specifies a user (speaker) who has given the setting instruction. Specifically, the specification part 1420 uses a database (not shown) that stores voice characteristics of each of the plurality of users in association with identification information (hereinafter also referred to as “user ID”) of each user, to specify the user who has given the setting instruction. Typically, every time the voice receiving part 1410 receives a setting instruction, the specification part 1420 specifies the user who has given the setting instruction. That is, the specification part 1420 specifies the user who has given the setting instruction without waiting for a job execution instruction.

Further, the specification part 1420 specifies a user (speaker) who has given the job execution instruction. Specifically, the specification part 1420 uses a database (not shown) to specify the user who has given the job execution instruction.

In a case where the instruction content is a setting instruction, the specification part 1420 notifies the association part 1430 of the setting instruction and the user ID of the user who has given the setting instruction.

In a case where the user who has given the setting instruction is not able to be identified, the specification part 1420 performs processing on the assumption that the setting instruction has been given by a public user (that is, the public user is specified as the user who has given the setting instruction). Specifically, the specification part 1420 notifies the association part 1430 of the setting instruction and a user ID indicating the public user.

In a case where the instruction content is a job execution instruction, the specification part 1420 sends a notification indicating the specified user ID and the fact of receiving the job execution instruction, to the job execution control part 1450.

In a case where the user who has given the job execution instruction is not able to be identified, the specification part 1420 performs processing on the assumption that the job execution instruction has been given by a public user (that is, the public user is specified as the user who has given the job execution instruction). Specifically, the specification part 1420 sends a notification indicating a user ID indicating the public user and the fact of receiving the job execution instruction, to the job execution control part 1450.

(d3. Association Part 1430)

The association part 1430 receives, from the specification part 1420, a setting according to the setting instruction and a user ID of a user who has given the setting instruction. When the association part 1430 receives the setting and the user ID, the association part 1430 associates and stores the setting and the user ID in the data table 1501 of the storage part 1500.

Specifically, the association part 1430 writes the setting and the user ID in the data table 1501 in association with a time when the voice receiving part 1410 receives the setting instruction (voice input). Note that the association part 1430 receives information of the time when the voice input is received from the voice receiving part 1410, via the specification part 1420.

In a case where the specification part 1420 is not able to specify the user who has given the setting instruction, the association part 1430 receives a setting instruction and a user ID indicating a public user from the specification part 1420. When receiving the setting instruction and the user ID indicating the public user, the association part 1430 associates and stores the setting according to the setting instruction and the user ID indicating the public user, in the data table 1501 of the storage part 1500.

Specifically, the association part 1430 writes the setting and the user ID indicating the public user, in the data table 1501 in association with a time when the voice receiving part 1410 receives the setting instruction (voice input).

FIG. 6 is a schematic view showing an example of the data table 1501 stored in the image forming apparatus 1000.

Referring to FIG. 6, the data table 1501 stores settings and user IDs in association with times. The setting typically includes a setting item and a parameter for the setting.

The data table 1501 stores, for example, a number of copies, “2” that is a parameter value of the number of copies, and a user ID indicating a user A, in association with time information “15:31”. Further, the data table 1501 stores, for example, a number of copies, “4” that is a parameter value of the number of copies, and a user ID indicating a public user, in association with time information “15:44”.

Meanwhile, it suffices that the setting and the user ID are associated and stored in the data table 1501. For example, the association part 1430 may individually acquire the setting and the user ID from the specification part 1420. For example, the association part 1430 may write the setting first in the data table 1501 at a timing when the user is not identified. In this case, the association part 1430 may associate the user ID of the specified user with the setting stored in the storage part 1500, on the basis of the fact that the specification part 1420 has specified the user who has given the setting.

(d4. Job Execution Control Part 1450)

The job execution control part 1450 controls an operation of each device in the image forming apparatus 1000 so that a job is executed on the basis of the extracted setting. Specifically, the job execution control part 1450 causes the control target device 1100 to execute a necessary operation, by sending a command for executing the job to the control target device 1100. Details of the job execution control part will be described below.

The job execution control part 1450 receives, from the specification part 1420, a notification indicating a specified user ID or a user ID indicating a public user, and the fact of receiving a job execution instruction.

The job execution control part 1450 extracts a setting associated with the user ID of the same user as the user who has given the job execution instruction, from the data table 1501 of the storage part 1500, on the basis of the fact of receiving the job execution instruction after receiving the setting instruction. The job execution control part 1450 causes a job to be executed on the basis of the extracted setting.

For example, in a case where the setting instructions shown in FIG. 6 are stored in the data table 1501, the job execution control part 1450 extracts a setting associated with the user A (specifically, a user ID indicating the user A) from the data table 1501 when a job execution instruction (specifically, a copy execution instruction) is given by the user A by voice. Furthermore, the job execution control part 1450 causes a job to be executed on the basis of the extracted setting.

Specifically, the job execution control part 1450 extracts the “two copies” setting, the “4-in-1” setting, and the “color copy” setting from the data table 1501, and causes the job to be executed with a combined setting of the three extracted settings.

In addition, when the user who has given the job execution instruction is not identified, the job execution control part 1450 extracts a setting associated with a user ID of the public user from the data table 1501, and causes the job to be executed on the basis of the extracted setting.

In addition, after the job is executed on the basis of the job execution instruction, when a new job execution instruction is received from a user (another user) other than the user who has given the job execution instruction, the job execution control part 1450 extracts, from the data table 1501, a setting associated with a user ID of the same user as the user who has given the new job execution instruction. Furthermore, the job execution control part 1450 sets the extracted setting as the setting for the another user. Furthermore, the job execution control part 1450 causes a job to be executed based on the new job execution instruction, with the setting for the another user.

For example, when the user B gives a job execution instruction (in this example, a copy execution instruction) by voice after a job execution instruction (in this example, a copy execution instruction) is given by the user A as described above, the job execution control part 1450 extracts the “three copies” setting and the “copying (default black and white copying)” setting from the data table 1501, and sets a combined setting of the two extracted settings as a setting for the user B. Further, the job execution control part 1450 causes the copying to be executed with the setting for the user B.

Note that the image forming apparatus 1000 may prohibit execution of the job when the user who has given the job execution instruction is not identified.

(d5. Display Control Part 1460)

The display control part 1460 controls display contents on the display of the operation panel 34. The display control part 1460 causes the display to display various images (screens).

FIGS. 7, 8, and 9 are views for explaining screens displayed on the display of the operation panel 34.

Referring to FIG. 7, every time a setting instruction is received, the display control part 1460 causes a display 341 of the operation panel 34 to display information based on the user ID of the user who has given the setting instruction and a content of the setting instruction. Typically, the display control part 1460 causes the display 341 to display an object 3411 in which a user name and the content of the setting instruction are represented by characters or the like, in a state of being superimposed on a screen immediately before the object 3411 is displayed.

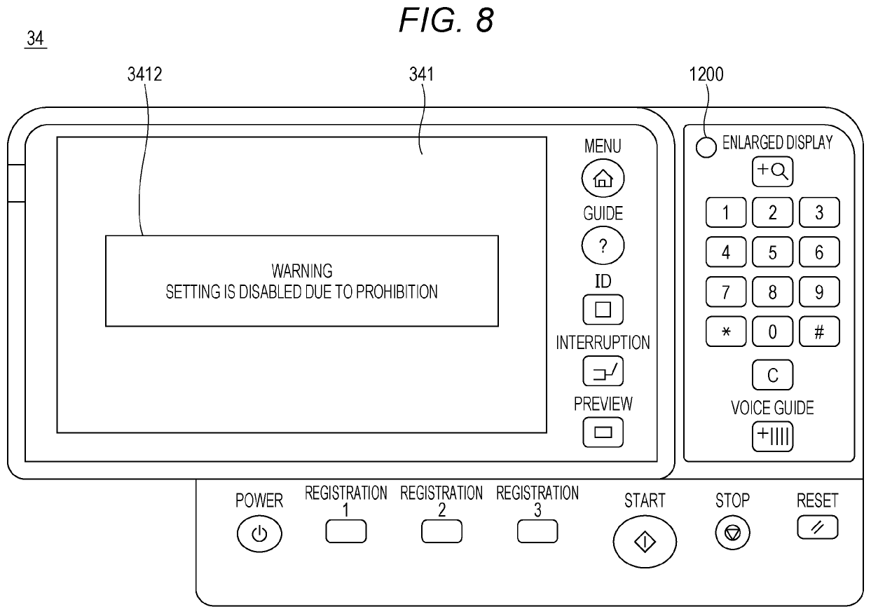

Referring to FIG. 8, the display control part 1460 causes the display of the operation panel 34 to display a predetermined warning, when a combination of the setting based on the setting instruction (setting content) and the setting based on the existing setting instruction given by the same user as the user who has given the setting instruction is prohibited. Typically, the display control part 1460 causes the display 341 to display an object 3412 in which the fact of being prohibited is represented by characters or the like, in a state of being superimposed on a screen immediately before the object 3412 is displayed.

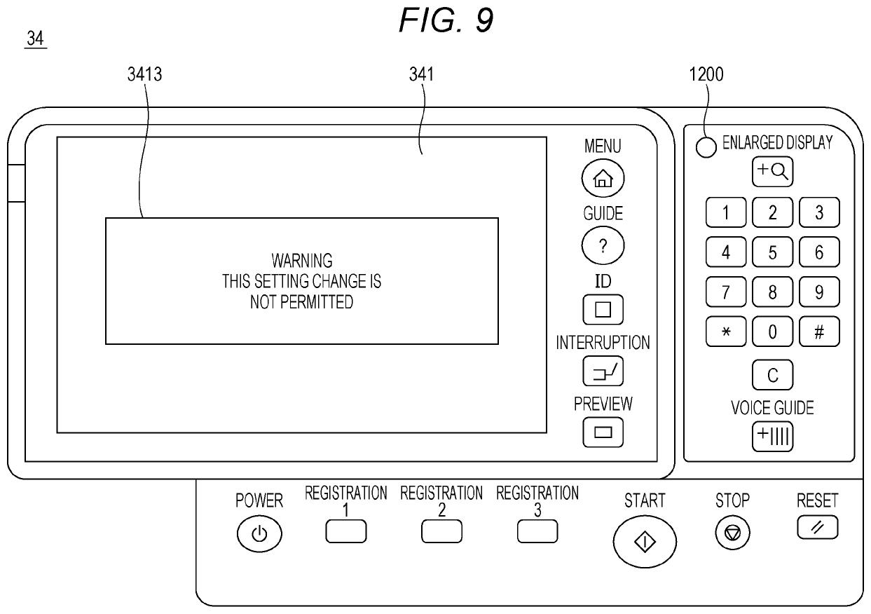

Referring to FIG. 9, when a setting based on the setting instruction is not permitted to the user who has given the setting instruction, the display control part 1460 causes the display of the operation panel 34 to display a predetermined warning. Typically, the display control part 1460 causes the display 341 to display an object 3413 in which the fact that the setting is not permitted is represented by characters or the like, in a state of being superimposed on a screen immediately before the object 3413 is displayed.

In addition, upon receiving the job execution instruction, the display control part 1460 may cause the display of the operation panel 34 to display information (for example, a user name) based on the user ID of the user who has given the job execution instruction, and the setting associated with a user ID of the same user as the user who has given the job execution instruction.

<E. Control Structure>

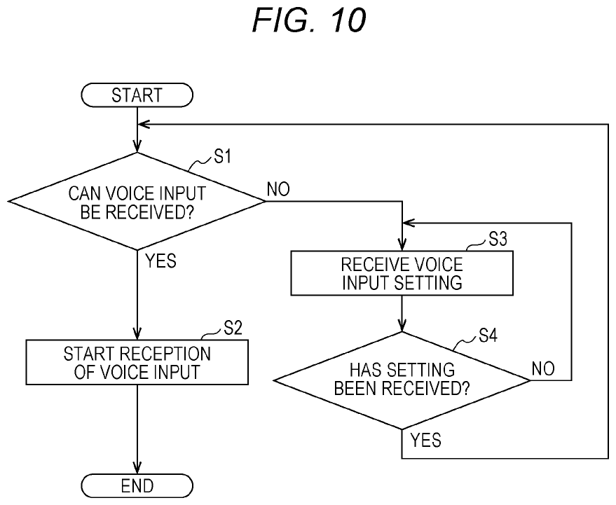

FIG. 10 is a flowchart showing a processing flow until reception of a voice input is started.

Referring to FIG. 10, in step S1, the controller 31 determines whether or not a voice input can be received. Specifically, the controller 31 determines whether or not the current operation mode is a mode for receiving a voice input.

When it is determined that a voice input is possible (YES in step S1), the controller 31 starts reception of the voice input in step S2. When it is determined that a voice input is not possible (NO in step S1), the controller 31 receives a voice input setting in step S3. For example, the controller 31 receives a user operation for changing to a mode for receiving a voice input, for example, via the operation panel 34.

When it is determined that the voice input setting has been received (YES in step S4), the controller 31 advances the process to step S1. In this case, since a positive determination is made in step S1, the controller 31 advances the process to step S2. When it is determined that the voice input setting has not been received (NO in step S4), the controller 31 returns the process to step S3.

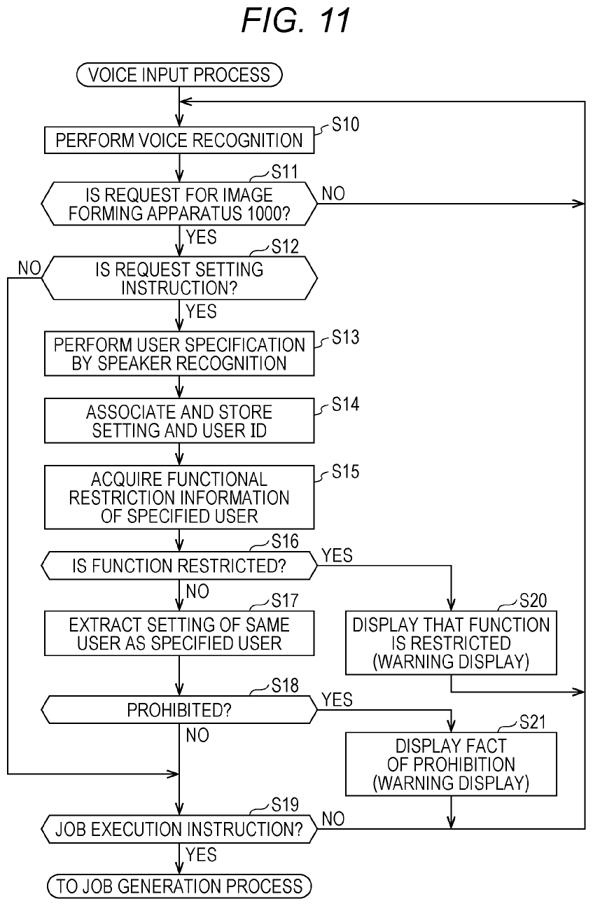

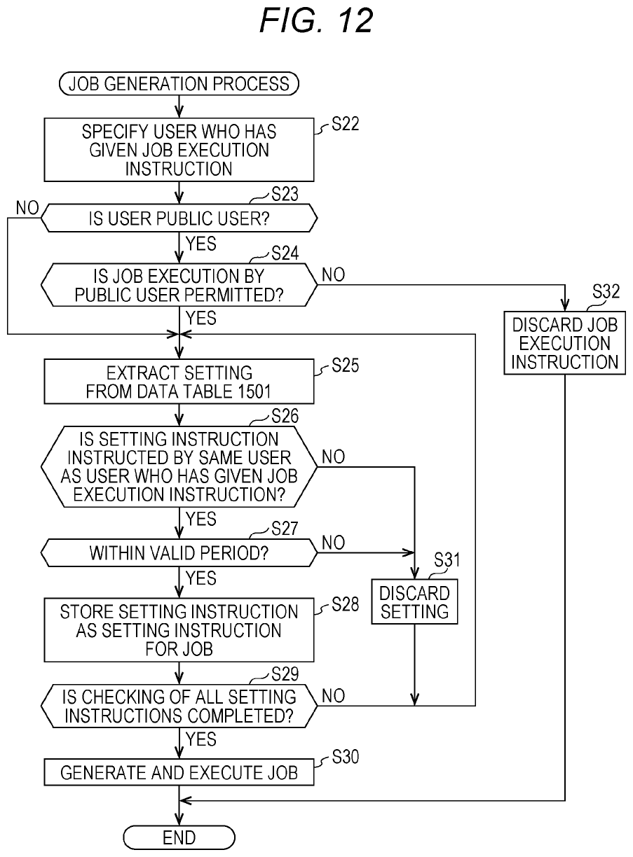

FIG. 11 is a flowchart for explaining a first half of a processing flow of the image forming apparatus 1000 when a voice input is received. FIG. 12 is a flowchart for explaining a second half of the processing flow of the image forming apparatus 1000 when a voice input is received.

Referring to FIG. 11, in step S10, the controller 31 performs voice recognition on voice collected via the microphone 1200. In step S11, the controller 31 determines whether or not the inputted voice is a request for the image forming apparatus 1000. For example, the controller 31 determines whether or not the voice matches a content stored in a database (not shown).

When it is determined that the request is for the image forming apparatus 1000 (YES in step S11), the controller 31 determines in step S12 whether or not the request is a setting instruction. For example, the controller 31 determines whether or not the voice matches an instruction content stored in a database (not shown). When it is determined that the request is not for the image forming apparatus 1000 (NO in step S11), the controller 31 discards the request and returns the process to step S11.

When it is determined that the request is a setting instruction (YES in step S12), the controller 31 performs user specification by speaker recognition in step S13. That is, the controller 31 specifies a speaker of voice from a plurality of registered users. When it is determined that the request is not a setting instruction (NO in step S12), the controller 31 advances the process to step S19. In addition, when the controller 31 is not able to identify a speaker of voice, the controller 31 performs processing on the assumption that the speaker is a public user.

In step S14, the controller 31 associates and stores the setting according to the setting instruction and the user ID, in the memory. Specifically, the controller 31 associates and writes the content of the setting instruction, the user ID, and time information, in the data table 1501 of the storage part 1500 (see FIG. 6). Note that, in this case, the controller 31 causes the display 341 of the operation panel 34 to display the user name and the content of the setting instruction (see FIG. 7).

In step S15, the controller 31 acquires a content of a functional restriction set in advance for the specified user, from the server device 3000 (see FIG. 1). Specifically, the image forming apparatus 1000 logs in to the server device 3000, and acquires functional restriction information set (restriction information) for the specified user from the server device 3000. Note that, in a case where the login operation to the server device 3000 by the image forming apparatus 1000 is not necessary, the image forming apparatus 1000 acquires the functional restriction information from the server device 3000 without the login operation.

Meanwhile, in a case where the image forming apparatus 1000 stores functional restriction information for each user, it is not necessary to acquire the functional restriction information from the server device 3000. Further, in a case where the image forming apparatus 1000 has previously acquired the functional restriction information for each user from the server device 3000, the process of step S15 is not necessary.

Note that the functional restriction includes a restriction that is not assumed to be changed with lapse of time, such as a predetermined operation being prohibited, and a restriction that can be changed with lapse of time, such as a number of remaining usable paper.

In step S16, the controller 31 determines whether or not the content of the setting instruction is a restricted function. Specifically, the controller 31 determines whether or not the content of the setting instruction is included in the acquired functional restriction information. Specifically, the controller 31 determines whether or not the setting instruction corresponds to a matter that is not permitted for the specified user. For example, when the setting instruction is color copy, the controller 31 uses the functional restriction information of the user to determine whether or not color copy is permitted for the user who has given the setting instruction.

When the content of the setting instruction is a restricted function (YES in step S16), the controller 31 displays in step S20 that the content of the setting instruction is a restricted function. That is, the controller 31 causes the display 341 of the operation panel 34 to display that the setting instruction is not permitted. Specifically, the controller 31 displays the object 3413 on the display 341 of the operation panel 34 (see FIG. 9).

In the example of the flowchart, the controller 31 executes processing of step S16 every time voice recognition is performed. Such a configuration enables a warning to be displayed immediately as shown in step S20 every time the user gives a setting instruction that is not permitted. As a result, usability can be improved.

However, without limiting to such a configuration, the controller 31 may perform processing shown in step S16 when receiving a job execution instruction. In this case, since an amount of data processing when a setting instruction is received is reduced, the controller 31 can speed up the response when receiving the setting instruction.

In step S17, the controller 31 extracts a setting (a content of the setting instruction) of the same user as the specified user. Specifically, the controller 31 extracts the setting stored in the data table 1501 in association with the user ID of the specified user, from the data table 1501.

In step S18, the controller 31 determines whether or not a combination of the extracted setting (that is, a content of the setting instruction inputted earlier) and the setting (a content of the setting instruction) inputted this time is prohibited. Meanwhile, the controller 31 may simply determine whether or not the settings are prohibited on the basis of a predetermined rule.

When it is determined as being prohibited (YES in step S18), the controller 31 causes the display 341 of the operation panel 34 to display the fact of the prohibition in step S21.

In the example of the flowchart, the controller 31 executes processing of step S18 every time voice recognition is performed. Such a configuration enables a warning to be displayed immediately as shown in step S21 every time the user gives a setting instruction that is prohibited. As a result, usability can be improved.

However, without limiting to such a configuration, the controller 31 may perform processing shown in step S18 when receiving a job execution instruction. In this case, since an amount of data processing when a setting instruction is received is reduced, the controller 31 can speed up the response when receiving the setting instruction.

In step S19, the controller 31 determines whether or not the above-described request is a job execution instruction. For example, the controller 31 determines whether or not the voice matches an instruction content stored in a database (not shown).

When it is determined that the request is a job execution instruction (YES in step S19), the controller 31 advances the process to a job generation process. When it is determined that the request is not a job execution instruction (NO in step S19), the controller 31 discards the request and returns the process to step S10.

Note that, when the request is a setting instruction, a negative determination is made in step S19 and the process returns to step S10. Therefore, the user can input a further setting instruction before inputting the job execution instruction. Further, the controller 31 may perform a user specification process by speaker recognition shown in step S13 for all setting instructions after receiving the job execution request.

Referring to FIG. 12, in step S22, the controller 31 specifies a user who has given the job execution instruction, by speaker recognition.

In step S23, the controller 31 determines whether or not the user who has given the job execution instruction is a public user. That is, the controller 31 determines whether or not the user who has given the job execution instruction has been unable to be specified.

When it is determined that the user who has given the job execution instruction is a public user (YES in step S23), the controller 31 determines in step S24 whether or not job execution by the public user is permitted. That is, the controller 31 determines whether or not the operation mode is a mode for allowing a public user to execute a job.

When job execution by the public user is permitted (YES in step S24), the controller 31 extracts a setting from the data table 1501 in step S25. Typically, in step S25, the controller 31 extracts one setting that has not yet been extracted. When job execution by the public user is not permitted (NO in step S24), the controller 31 discards the job execution instruction in step S32. Typically, the job execution is deleted from the data table 1501.

In step S26, the controller 31 determines whether or not the extracted setting is a setting instructed by the same user as the user who has given the job execution instruction. Specifically, in the data table 1501, on the basis of the user ID associated with the setting, the controller 31 determines whether or not the extracted setting is a setting instructed by the same user as the user who has given the job execution instruction.

When it is determined as being not the same user (NO in step S26), the controller 31 discards the setting instruction in step S31. Typically, the setting instruction is deleted from the data table 1501. Thereafter, the controller 31 returns the process to step S25.

Meanwhile, when it is determined that the setting instruction is given by a public user, there is a possibility that the setting instruction is treated as a setting instruction given by the public user due to erroneous voice recognition, even though a registered user gives the setting instruction. Therefore, in this case, whether or not to save the setting instruction as a setting instruction for the job may be inquired with use of a screen or the like before discarding the setting instruction, for the registered user (the user who has given the job execution instruction).

In this way, when the job execution instruction is received, the display control part 1460 may cause the operation panel 34 to display a display for inquiring whether a setting based on the setting instruction is necessary or not, in a case where the user who has given the setting instruction has not been specified.

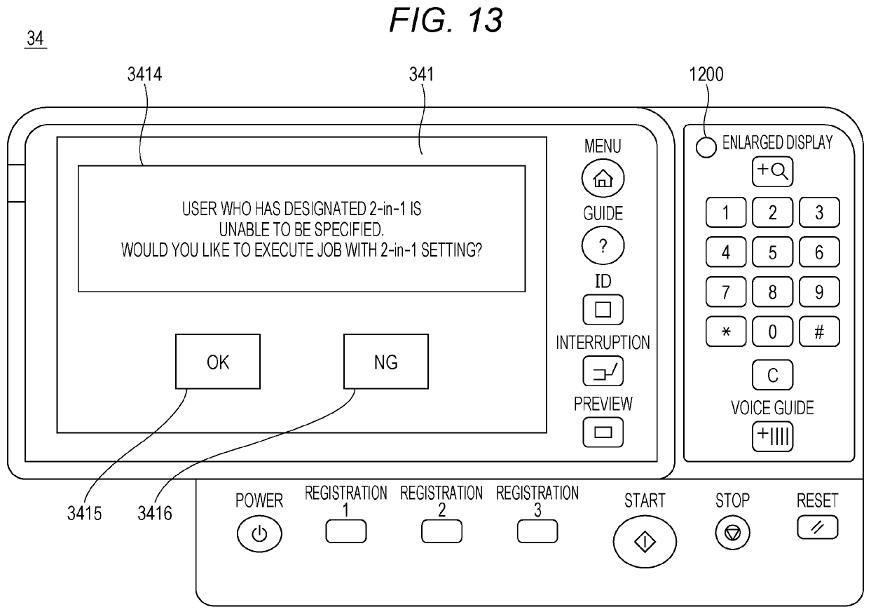

FIG. 13 is a view for explaining a screen displayed on the display of the operation panel 34 when an inquiry to a job execution user is made. Referring to FIG. 13, the display control part 1460 causes the display of the operation panel 34 to display a screen for inquiring whether or not to save the setting instruction as the setting instruction for the job, before discarding the setting instruction. Typically, the display control part 1460 causes the display 341 to display an object 3414 for inquiring, in a state of being superimposed on a screen immediately before the object 3414 is displayed. Note that the object 3414 includes a software button 3415 to instruct saving as the setting instruction for the job, and a software button 3416 not to instruct saving.

When it is determined as being the same user (YES in step S26), the controller 31 determines in step S27 whether or not the setting instruction is within a valid period. When the setting instruction is not within the valid period (NO in step S27), the controller 31 discards the setting instruction in step S31. Specifically, the setting instruction is deleted from the data table 1501. Thereafter, the controller 31 returns the process to step S25.

For example, the valid period can be a period from when the setting instruction is received until a predetermined time (for example, several minutes) elapses. Specifically, the valid period can be a period from when the setting instruction is stored in the storage part 1500 until a predetermined time elapses.

Meanwhile, in a case where the same setting instruction is continuously received from the same user for a predetermined number of times per unit time, it is possible that voice recognition is incorrect. Therefore, the controller 31 may discard (invalidate) the continuous setting instructions in such a case. This process is desirably used in combination with a process based on the valid period.

When the setting instruction is within the valid period (YES in step S27), the controller 31 stores the setting instruction as the setting instruction for the job in step S28. In step S29, the controller 31 determines whether or not checking of all setting instructions (extraction and confirmation processing as to whether or not as being the same user) stored in the data table 1501 has been completed.

When it is determined that checking of all setting instructions is not completed (NO in step S29), the controller 31 returns the process to step S25. When it is determined that checking of all setting instructions is completed (YES in step S29), in step S30, the controller 31 generates a job on the basis of one or more setting instructions stored as the setting instruction for the job, and executes the job.

Note that all setting instructions can be, for example, all setting instructions within a predetermined period. The controller 31 may delete the setting instruction from the data table 1501 after a predetermined period, and check all setting change instructions remaining in the data table 1501 in step S29.

<F. Modifications>

(1) In the above, a description has been made with an example of a configuration in which the specification part 1420 specifies a user who has given a setting instruction when the voice receiving part 1410 has received the setting instruction. However, the present invention is not limited to this.

For example, the control part 1400 (controller 31) of the image forming apparatus 1000 may have a configuration in which the specification part 1420 specifies a user who has given the setting instruction when the voice receiving part 1410 has received a job execution instruction.

According to such a configuration, the image forming system 1 does not need to perform speaker recognition by voice every time a setting instruction is received. Accordingly, the image forming system 1 can perform speaker recognition at a timing with a low load, for example. Therefore, the accuracy of speaker recognition can also be increased.

(2) The display control part 1460 may cause the operation panel 34 to display a predetermined warning, when at least one of the settings stored in the storage part 1500 in association with the user ID (identification information) of the same user as the user who has given the job execution instruction is not permitted for the user. According to such a configuration, the user can know that the setting instruction given by the user is not appropriate.

(3) The image forming apparatus 1000 may hold an extracted setting in association with the user ID of the user who has given the job execution instruction, on the basis of the fact of receiving the job execution instruction. In that case, when the voice receiving part 1410 receives a new job execution instruction from the same user as the user who has given the job execution instruction, the job execution control part 1450 may simply cause a job to be executed based on the new job execution instruction with the setting held in association with the user ID of the user.

According to such a configuration, when the user who has given the job execution instruction gives a job execution instruction again, the image forming apparatus 1000 executes the job with the same setting as the previous setting. Therefore, the user does not need to make the same setting again.

Because it may be desired to set a different setting from the previous setting, the image forming apparatus 1000 is desirably capable of receiving an instruction to invalidate the setting that has already been made (a voice input or an input to the operation panel). For example, it is desirable that the image forming apparatus 1000 returns to a default setting when a predetermined instruction is received.

(4) In the above, a description has been made with an example of a configuration in which the image forming apparatus 1000 specifies a user who has given a setting instruction and a user who has given a job execution instruction. However, the present invention is not limited to this. For example, the server device 3000 may specify a user who has given a setting instruction and a user who has given a job execution instruction.

Further, the server device 3000 may receive, by voice, a setting instruction related to a setting of a job to be executed by the image forming apparatus 1000 and a job execution instruction for causing the job to be executed.

Further, on the basis of the fact that the user who has given the setting instruction is specified, the server device 3000 may associate and store a setting according to the setting instruction and identification information of the specified user, in a storage in the server device 3000. Further, in this case, on the basis of the fact that the job execution instruction is received after the setting instruction is received, the server device 3000 may extract a setting associated with the identification information of the same user as the user who has given the job execution instruction, from the storage of the server device 3000.

The server device 3000 may have at least one of a function of the voice receiving part 1410, a function of the specification part 1420, or a function of the association part 1430. In other words, any configuration may be used as long as the image forming apparatus 1000 and the server device 3000 cooperatively perform various processes, and the image forming apparatus 1000 executes a job at the end.

(5) In the above, a description has been made with an example of a configuration in which the specification part 1420 specifies a speaker of voice from a plurality of users registered in advance. However, the present invention is not limited to this, and the users need not be registered in advance. The image forming system 1 may have a configuration in which matching between the user who has given the setting instruction and the job execution instruction is exclusively determined, and then the image forming apparatus 1000 executes the job.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming apparatus comprising:
a hardware processor that:
receives, by voice of a first user, a setting instruction related to a setting of a job executed by the image forming apparatus;
receives, by voice of a second user, an operation instruction for executing the job;
specifies the first user and the second user based on the voices;
associates and stores, in a storage, a setting according to the setting instruction and identification information of the first user; and
extracts from the storage, upon receiving the operation instruction after receiving the setting instruction, the setting associated with identification information of the second user, and executes the job based on the extracted setting.

2. The image forming apparatus according to claim 1, further comprising:
an operation panel, wherein
the hardware processor causes the operation panel to display a predetermined warning when a combination of a first setting and a second setting is prohibited, and
the first setting is based on the setting instruction newly received, and the second setting is based on the setting instruction that has been given by the first user.

3. The image forming apparatus according to claim 1, wherein
the hardware processor uses a database that stores a voice characteristic of each of a plurality of users to specify the first user,
each of the users is associated with identification information, and
when the hardware processor is unable identify the first user from the database, the hardware processor specifies the first user as a public user.

4. The image forming apparatus according to claim 3, wherein
the hardware processor uses the database to specify the second user, and
when the hardware processor is unable to identify the second user from the database, the hardware processor specifies the second user as a public user.

5. The image forming apparatus according to claim 4, wherein
when the hardware processor is unable to identify the first user from the database, the hardware processor associates the identification information of the public user with the setting stored in the storage, and
when the hardware processor is unable to identify the second user from the database, the hardware processor extracts, from the storage, the setting associated with the identification information of the public user, and executes the job based on the extracted setting.

6. The image forming apparatus according to claim 1, wherein
every time the hardware processor receives the setting instruction, the hardware processor specifies another user who has given the setting instruction.

7. The image forming apparatus according to claim 6, further comprising:
an operation panel, wherein
a hardware processor causes the operation panel to display a predetermined warning when the setting based on the setting instruction is not permitted to the first user.

8. The image forming apparatus according to claim 1, wherein
upon receiving the operation instruction, the hardware processor specifies the first user.

9. The image forming apparatus according to claim 8, further comprising:
an operation panel, wherein
the hardware processor causes the operation panel to display a predetermined warning when at least one of settings of the job is not permitted to the first user, and
the settings are stored in the storage in association with the identification information of the second user.

10. The image forming apparatus according to claim 1, wherein
upon receiving the operation instruction, the hardware processor holds the extracted setting in association with the identification information of the second user, and
upon receiving another operation instruction from the second user, the hardware processor executes the job based on the other operation instruction with the setting held in association with the identification information of the second user.

11. The image forming apparatus according to claim 1, wherein
upon receiving another operation instruction from a user other than the second user after executing the job based on the operation instruction, the hardware processor extracts, from the storage, the setting associated with identification information of that other user, and sets the extracted setting, and executes the job based on the other operation instruction with the setting.

12. The image forming apparatus according to claim 1, wherein
the setting is deleted from the storage when a predetermined time has elapsed since the setting instruction has been stored in the storage.

13. The image forming apparatus according to claim 1, wherein,
when the same setting instruction is received from the same user more than a predetermined number of times per unit time, the same setting instruction is invalidated.

14. The image forming apparatus according to claim 1, further comprising
an operation panel, wherein
the hardware processor causes the operation panel to display the identification information of the first user and a content of the setting instruction.

15. The image forming apparatus according to claim 1, further comprising
an operation panel, wherein
upon receiving the operation instruction, the hardware processor causes the operation panel to display the identification information of the second user and the setting instruction associated with the identification information of the second user.

16. The image forming apparatus according to claim 1, wherein
execution of the job is prohibited when the second user is not identified.

17. The image forming apparatus according to claim 1, further comprising
an operation panel, wherein
upon receiving the operation instruction when the first user is not identified, the hardware processor causes the operation panel to display a display for inquiring whether the setting is necessary based on the setting instruction.

18. An image forming system comprising an image forming apparatus and an information processing apparatus communicating with the image forming apparatus, wherein
one of the image forming apparatus or the information processing apparatus receives, by voice of a first user, a setting instruction related to a setting of a job executed by the image forming apparatus and receives, by a voice of a second user, an operation instruction for executing the job,
one of the image forming apparatus or the information processing apparatus specifies the first user and the second user based on the voices,
one of the image forming apparatus or the information processing apparatus associates and stores, in a memory, a setting according to the setting instruction and identification information of the first user,
one of the image forming apparatus or the information processing apparatus extracts from the memory, upon receiving the operation instruction after receiving the setting instruction, the setting associated with identification information of the second user, and
the image forming apparatus executes the job based on the extracted setting.

19. An information processing method comprising:
receiving, by voice of a first user and with a hardware processor of an image forming apparatus, a setting instruction related to a setting of a job executed by the image forming apparatus;
associating and storing in a memory, with the hardware processor, a setting according to the setting instruction and identification information of the first user specified as having given the setting instruction;
receiving, by voice of a second user and with the hardware processor, an operation instruction for executing the job by the image forming apparatus;
extracting, from the memory, the setting associated with identification information of the second user upon receiving the operation instruction after receiving the setting instruction; and
executing, by the hardware processor, the job based on the extracted setting.
